(19) United States
(12) Patent Application Publication
(10) Pub. No.: US 2020/0408183 A1
(43) Pub. Date: Dec. 31, 2020

(54) WIND OR MARINE ENERGY CAPTURE SYSTEM

(71) Applicant: MANUEL MUNOZ SAIZ, ALMERIA (ES)

(72) Inventor: MANUEL MUNOZ SAIZ, ALMERIA (ES)

(21) Appl. No.: 16/911,745

(22) Filed: Jun. 25, 2020

(30) Foreign Application Priority Data
Jun. 25, 2019 (ES) U201900326

(51) Int. Cl. F03B 3/12; F03B 13/10; F03D 5/00; F03D 9/25

(52) U.S. Cl. CPC F03B 3/121; F03D 9/25; F03D 5/00; F03B 13/10

(57) ABSTRACT

The wind or marine energy capture system uses paragliders, elliptical or rhomboidal kites that are rotated, twisted or with fins on portions of their trailing or leading edges of the major edges and held at their ends by cables or cords, which by the action of the wind or water rotate around its axis and apply the rotational movement to an electric generator or mechanical element to move to the ground. Paragliders or elliptical kites, etc. they are directed by the wind automatically without having to apply any energy to it.

### INDEX TO RELATED APPLICATIONS

This application claims the benefit of Spanish application U201900326, filed Jun. 25, 2019, the disclosure of which is incorporated herein by reference in its entirety.

### FIELD OF INVENTION

In wind and marine capturing systems, which generate electricity for homes, agriculture, desalination of sea water, water elevation, feedback of current to the electrical network, obtaining hydrogen by electrolysis of water, storage of water in elevated dams and air pressure in bags or containers in the sea at great depth.

### STATE OF THE TECHNOLOGY

The current wind and marine energy systems need high technologies, high costs, placement at high altitudes and high winds to achieve high yields, depending on wind conditions difficult to find. They are difficult to control and complex. The energy is more expensive than with conventional systems. The present invention eliminates such inconveniences by providing a simple, useful and economic system, using elliptical kites or rotating paragliders or similar attached from their ends by cables or cords.

### DESCRIPTION OF THE INVENTION

### Objective of the Invention and Advantages

To use high winds, obtaining a reduced cost of the Kw/h.

To provide a simple, economic and high performance system that does not pollute, does not kill birds or fish, does not produce noise, vibrations, radio interference and is automatically self-directed without electrical mechanisms.

To be able to obtain electricity, hydrogen, seawater desalination, and pneumatic storage on the seabed. To be able to use electric, synchronous, multi-polar generators, with rpm multipliers, or installations with air compressors or hydraulic pumps driven directly by the turbine shafts.

### Problem to be Solved

The current wind and marine energy systems need high technologies, high costs, placement at high heights and high winds, in the wind, to achieve high performance, depending on wind conditions difficult to find. They are difficult to control and complex.

The present invention solves most of these disadvantages.

The wind or marine energy capture system of the invention, using paragliders, elliptical, rhomboidal, rectangular or half cane kites, rotating, twisted or with some fins in portions of their leading or trailing edges and are fastened from their ends by means of cables or cords, which by the action of the wind or water apply the turning movement to an electric generator or mechanical element to be moved, fastened to the ground or to a vehicle. The turbines: paragliders or elliptical kites, etc. are automatically oriented by the wind, or the water current, without having to apply any energy to do so. For the half-rounded ones, it is enough to add the protruding fins or to make some recesses or hollows in these portions of symmetrical edges with respect to the axis of rotation. In this case the cables could be removed and an axis used. When they are small they can be rigid. All the rectangular ones can have a partition or fin at their outermost ends to prevent the fluid from being thrown out centrifugally.

They can be reinforced peripherally by means of tubular elements filled with compressed air, which facilitate their extension. They can have rounded corners, especially rhomboidal ones.

In large turbines, rpm multipliers can be applied between the turbine and the generators, or synchronous generators or multi-pole generators can be used.

Whenever possible, the mechanical energy obtained can be used to raise and store water in small dams, and to compress air, storing it in flexible containers submerged in the sea at medium or great depths until the time of use.

Non-oxidizable materials based on steel, zinc, fiberglass or carbon can be used. And fabrics or canvases made of natural or synthetic fibres reinforced with graphene.

Protection from strong winds is achieved by: a) Using elastic cords that retract or deform the surface facing the wind, or b) Electrically retracting the paraglider or row of paragliders, when a wind speed sensor detects a certain intensity. A balloon or kite-shaped balloon can be placed at the ends of the turbine rows. These make it easier to lift the paraglider.

The power obtained is proportional to the cube of the wind speed, therefore at a double speed the power will be eight times greater. The important property of this system is to use the strong winds that there are in height.

The system can be colored orange, red or green.

Strobe lights are applied to determine and warn of your situation.

The turbine cables can be partially conductive and grounded to prevent static current discharges, lightning strikes, etc.

In general, all turbines can be flexible, rigid or semi-rigid.

### BRIEF DESCRIPTION OF THE DRAWINGS

FIG. 1 shows a schematic and perspective view of a turbine of the invention in the form of a paraglider.

FIG. 2 shows a schematic and perspective view of a turbine variant.

FIG. 3 shows a schematic, plan view of a flat canvas of a paraglider.

FIG. 4 shows a schematic plan view of a paraglider fin with a curved shape, with fixed or adjustable fins on the leading or trailing edges.

FIG. 5 shows a schematic plan view from the bottom of a paraglider with a curved shape, with fixed or adjustable flaps at the leading or trailing edge.

FIG. 6 shows a schematic plan view from the top of a curved shaped paraglider with fixed or adjustable fins on the leading and trailing edges.

FIG. 7 shows a schematic plan view of a rhomboid shaped fin.

FIG. 8 shows a schematic plan view of a rectangular shaped turbine, of the half-round type, with some recesses or holes, which can be rigid.

FIG. 9 shows a schematic and perspective view of a variant of turbine whose fastening cables extend to the lower end next to the generator or engine to be moved.

FIG. 10 shows a schematic and perspective view of a turbine variant whose fastening cables are attached in the area near the sails and are connected to a single cable (3p) up to the lower area.

FIG. 11 shows a schematic and perspective view of a variant formed by multiple paragliders or sails in series.

FIG. 12 shows a schematic view of a variant of a glider or canopy in series, with a helium-filled balloon or float at the top, or air if it is a float, the helium makes it easier to lift.

### MORE DETAILED DESCRIPTION OF A FORM OF REALIZATION OF THE INVENTION

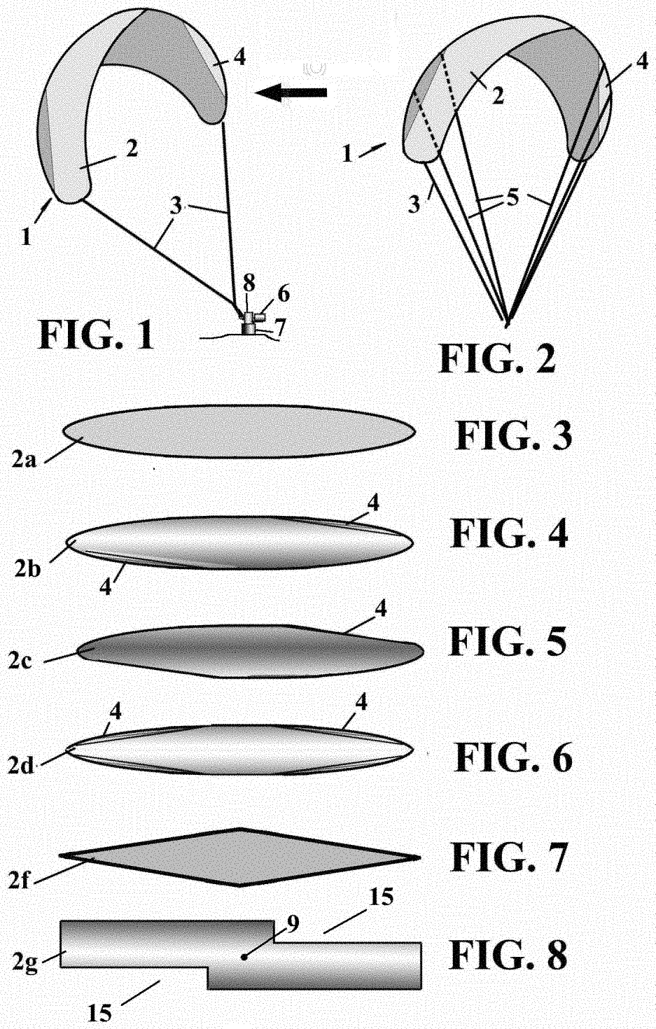

FIG. 1 shows a form of realization of the paraglider type turbine (1) formed by the sail (2), the cables of subjection of its two ends (3) and some fixed fins (4) in the edge of exit or of entrance of the sails that produce the turn of the assembly as turbine. The lower end is applied to the shaft of the electric generator (6), supported by the rotating support (8) which in turn is supported by the support (7) fixed to the ground,

FIG. 2 shows a variant of a paraglider type turbine (1) formed by the sail (2), the attachment cables at both ends (3) and variable fins (4) and controllable at the leading edge or trailing edge of the sail by means of the cables or cords (5), which produce the rotation of the assembly as a turbine. Optionally a winch can pick up the sail assembly.

FIG. 3 shows the canvas, cloth or flat sheet (2a).

FIG. 4 shows the curved canvas, cloth or foil (2b). with the control fins (4)

FIG. 5 shows the curved canvas, fabric or sheet (2c) with the fins (4) inclined.

FIG. 6 shows the curved canvas, fabric or sheet (2d) with the fins (4) inclined or fixed.

FIG. 7 shows the rhomboid-shaped canvas, fabric or sheet (2f). The fins are not shown and the corners must be rounded.

FIG. 8 shows a rectangular turbine of the roof tile (2g) or half cane type, with the recesses or gaps (15) symmetrical to the axis of rotation, which when rigid can carry a cable or an axis applied to the point (9) which is the axis of rotation. Likewise, when the air is perpendicular to the concave area, it tends to exit through the hollows or recesses, generating a torque. They can have a partition or flap at the outermost ends to prevent the fluid from being released centrifugally. This can be built completely as a rectangular parallelogram and instead of the recesses, hollows are made in the same places, but leaving a cord or peripheral band.

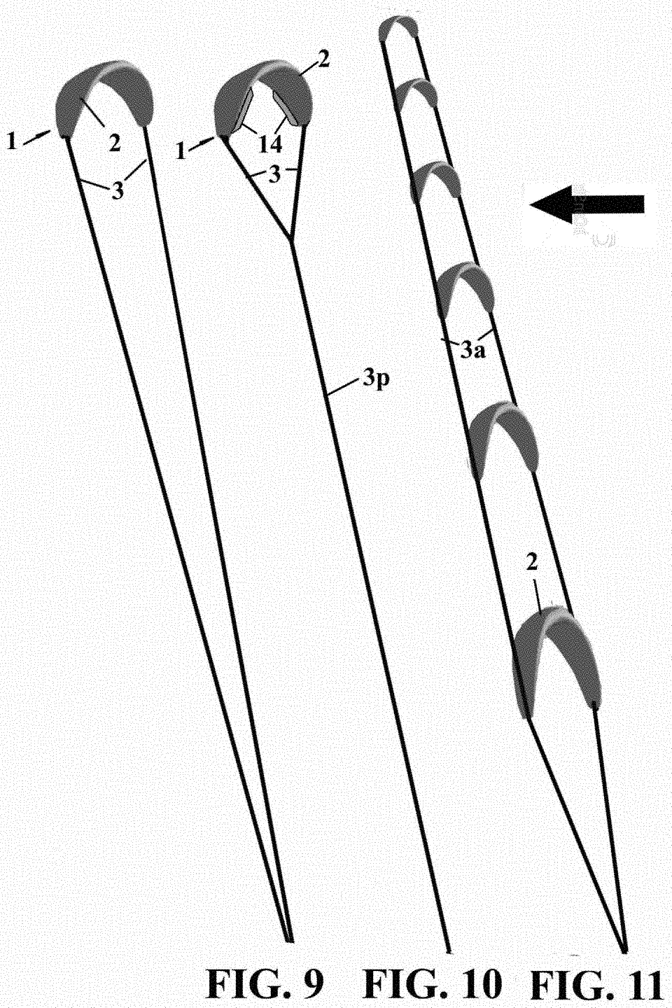

FIG. 9 shows the turbine (1) with the sail (2) and the cables (3), which transmit the rotation.

FIG. 10 shows the turbine (1) with the sail (2) and the cables (3), transmitting the rotation to the generator or motor by means of a single cable. In this case fins or skirts (14) are added at one end of each edge, which are arranged symmetrically with each other and deflect the flow of water or air and also produce a torque. This rotation can be varied by means of additional cords or cables, not shown in the figure, which vary the degree of extension or inclination of these fins or skirts.

FIG. 11 shows the turbine formed by multiple paragliders or sails (2), all of which are attached at their ends by the cables (3a).

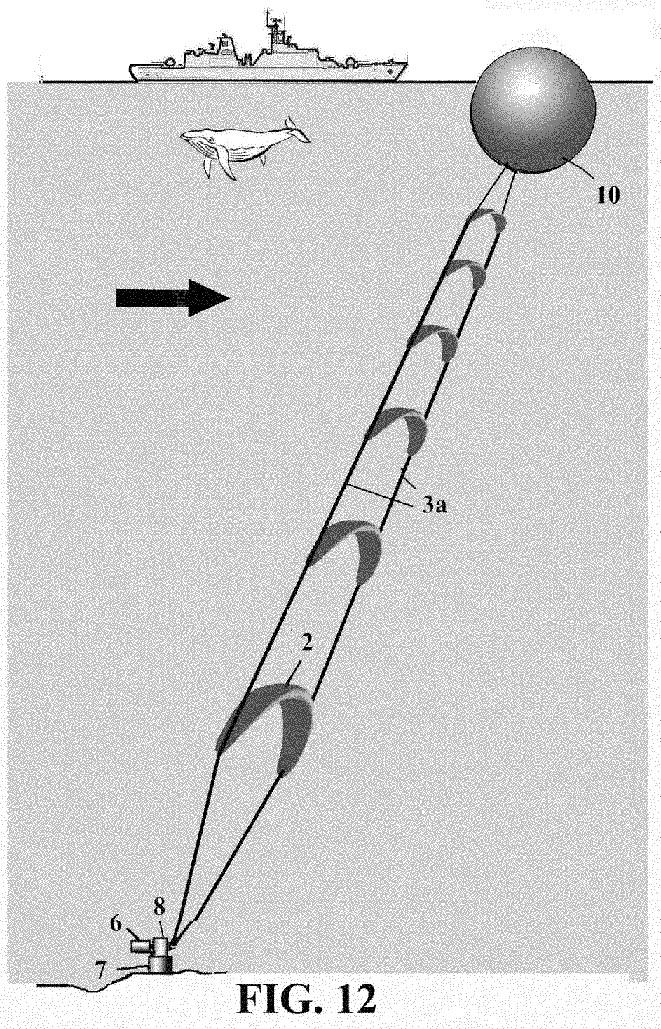

FIG. 12 shows the turbine formed by multiple paragliders or candles (2), all attached at their ends by the cables (3a). The lower end is applied to the shaft of the electric generator (6), supported by the rotating support (8) which in turn is supported by the support (7) fixed to the ground. At the free end it carries the float (10) which can be a balloon if it is a wind system. When it is a float, it can be of smaller dimensions and it does not need to protrude, it can be at a certain depth so that it does not hinder the traffic of the ships. The ship and the cetacean show their relative dimensions with the turbines.

FIGS. 11 and 12 do not show the fins that facilitate their rotation.

The figures also do not show the static current bypass system which shunts current to ground to avoid damaging people.

1. Wind or marine energy capture system, using turbines made up of paragliders, elliptical, rhomboidal, rectangular or half-round kites, rotating, twisted or with fins on portions of their leading or trailing edges and attached at their ends by cables or cords, which by the action of wind or water apply the movement of rotation generated to the axis of an electric generator or mechanical element to move, subject these to the ground or a vehicle, the paragliders or elliptical kites are oriented by the wind or water flow automatically.

2. System according to claim 1, wherein the turbines are reinforced peripherally by means of tubular elements filled with compressed air, which facilitate their extension.

3. System according to claim 1, wherein the turbines have fins or skirts (14) at the end of two edges symmetrical with respect to the axis of rotation, which deflect the flow of water or air and are controlled by additional cords or cables, which vary the degree of extension or inclination.

4. System according to claim 1, wherein the turbines are of rectangular type and have the shape of a tile (2g) or half a cane, with symmetrical recesses or hollows (15), which carry a partition or fin at its outermost ends and optionally carries a cable or an axis applied to point (9) which is the axis of rotation.

5. System according to claim 1, wherein are applied rpm multipliers between the turbines and the generators.

6. System according to claim 1, wherein the turbines use non-oxidizable materials based on steel, zinc, glass or carbon fibre and for the fabrics or canvases, natural or synthetic fibres reinforced with graphite.

7. System according to claim 1, wherein the turbines use a float, balloon, or kite-shaped balloon, filled with air or helium at the top end of the paraglider.

8. System according to claim 1, wherein the turbines are flexible and the fins have rounded corners.

9. System according to claim 1, wherein are used elastic cords and the turbines retract when the wind is excessive.

10. System according to claim 1, wherein the paragliders or rows of paragliders retract with an electric motor when a sensor detects strong wind.

11. System according to claim 1, wherein is applied orange, red or green colour and strobe lights to the system.

12. System according to claim 1, wherein are used cables that are conductors or semiconductors and they are electrically grounded.
